(19) United States
(12) Patent Application Publication
(10) Pub. No.: US 2016/0288575 A1
(43) Pub. Date: Oct. 6, 2016

(54) PNEUMATIC TIRE AND METHOD FOR MAKING A PNEUMATIC TIRE

(71) Applicant: The Goodyear Tire & Rubber Company, Akron, OH (US)

(72) Inventors: Phaniraj Muthigi, Copley, OH (US); David Ray Hubbell, Hartville, OH (US); Romain Jack Rodolphe Mersch, Mersch (LU)

(21) Appl. No.: 14/674,367

(22) Filed: Mar. 31, 2015

(51) Int. Cl. B60C 9/18; B29D 30/08; B60C 9/00

(52) U.S. Cl. CPC B60C 9/18; B60C 9/0028; B60C 9/0042; B29D 30/08; B60C 2009/0035

(57) ABSTRACT

A pneumatic tire includes an integrated belt/overlay component having a plurality of individually dipped and tackified cords applied individually to the tire component.

### FIELD OF INVENTION

This invention relates to pneumatic tires and, in particular, to passenger tires.

### BACKGROUND OF THE INVENTION

Conventional passenger tires utilize very wide treads which, in transverse cross-section, are sharply curved to provide good contact with the road surface when the motorcycle is steeply banked in cornering. Maintenance of a consistent ground contact area or ‘tire footprint’ under all conditions is a major factor in determining general vehicle handling. Of particular importance in race motorcycle tires of radial construction is a characteristic of high cornering power with stability to maximize cornering speeds under race conditions.

Conventional radial passenger tires have short sidewalls which extend to the tread edges radially and axially outwardly from the tires beads. The beads provide engagement to the wheel rim on tapered bead seats. The sidewalls are reinforced by radial carcass plies which, when tensioned by the inflation pressure, act together with sidewall geometry to provide a fixed location for the curved tread regions to withstand cornering forces.

The sharply curved tread region of the conventional tire may be specially reinforced by a reinforcing breaker to give the required structural rigidity to allow for banking of the automobile when cornering while also providing sufficient flexibility to allow localized tread flattening in the ground contact patch for good road grip.

A conventional passenger tire may use a center hard tread compound and differing shoulder tread compounds since some race circuits necessitate uneven shoulder wear and grip.

Conventional processes for producing these tires involve an extrusion or calendering step which increase production cost and which may increase scrap. Any new and innovative manner of producing tires with reduced cost would be commercially desirable.

### Definitions

The following definitions are controlling for the disclosed invention.

“Apex” means an elastomeric filler element located radially above the bead core and between the plies and the turnup ply.

“Annular” means formed like a ring.

“Aspect ratio” means the ratio of its section height to its section width.

“Axial” and “axially” are used herein to refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25°-65° angle with respect to equatorial plane of the tire. If multiple plies are present, the ply cords run at opposite angles in alternating layers.

“Breakers” means at least two annular layers or plies of parallel reinforcement cords having the same angle with reference to the equatorial plane of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Circumferential” means lines or directions extending along the perimeter of the surface of the annular tire parallel to the Equatorial Plane (EP) and perpendicular to the axial direction.

“Cord” means one or more twisted or untwisted yarns such as an assembly of a plurality of twisted yarns. “Cords” may also be referred to as one of the reinforcement strands of which the plies of the tire are comprised.

“Cord angle” means the acute angle, left or right in a plan view of the tire, formed by a cord with respect to the equatorial plane. The “cord angle” is measured in a cured but uninflated tire.

“Denier” means the weight in grams per 9000 meters (unit for expressing linear density). Dtex means the weight in grams per 10,000 meters.

“Elastomer” means a resilient material capable of recovering size and shape after deformation.

“Equatorial plane (EP)” means the plane perpendicular to the tire's axis of rotation and passing through the center of its tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“High Tensile Steel (HT)” means a carbon steel with a tensile strength of at least 3400 MPa @ 0.20 mm filament diameter.

“Inner” means toward the inside of the tire and “outer” means toward its exterior.

“LASE” is load at specified elongation.

“Lateral” means an axial direction.

“Lay length” means the distance at which a twisted filament or strand travels to make a 360 degree rotation about another filament or strand.

“Mega Tensile Steel (MT)” means a carbon steel with a tensile strength of at least 4500 MPa @ 0.20 mm filament diameter.

“Radial” and “radially” are used to mean directions radially toward or away from the axis of rotation of the tire.

“Sidewall” means that portion of a tire between the tread and the bead.

“Super Tensile Steel (ST)” means a carbon steel with a tensile strength of at least 3650 MPa @ 0.20 mm filament diameter.

“Tenacity” is stress expressed as force per unit linear density of the unstrained specimen (gm/tex or gm/denier). Used in textiles.

“Tensile” is stress expressed in forces/cross-sectional area. Strength in psi=12,800 times specific gravity times tenacity in grams per denier.

“Tread” means a molded, extruded, or shaped rubber component which, when bonded to a tire casing, includes that portion of the tire that comes into contact with the road when the tire is normally inflated and under normal load.

“Ultra Tensile Steel (UT)” means a carbon steel with a tensile strength of at least 4000 MPa @ 0.20 mm filament diameter.

“Yarn” is a generic term for a continuous strand of textile fibers or filaments. Yarn occurs in the following forms: 1) a number of fibers twisted together; 2) a number of filaments laid together without twist; 3) a number of filaments laid together with a degree of twist; 4) a single filament with or without twist (monofilament); 5) a narrow strip of material with or without twist.

### SUMMARY OF INVENTION

A pneumatic tire in accordance with the present invention includes an integral belt/overlay component having a plurality of individually dipped and individually tackified cords applied individually to the tire component. The component may be, for example, a tread reinforcement structure for improving high-speed performance and manufacturing of the pneumatic tire.

According to another aspect of the present invention, the cords are monofilaments or twisted yarns.

According to still another aspect of the present invention, the cords are aramid cords with a Dtex in a range of from 400 Dtex to 3500 Dtex, or from 1500 Dtex to 1800 Dtex, 1670 Dtex or 1680 Dtex.

According to yet another aspect of the present invention, the cords have a twist multiplier in a range of from 4 to 7, or 5 to 6. The “twist multiplier” refers to a number that is an indicator of the helix angle that the one or more yarns in a cord make with respect to a longitudinal axis of a cord. As used herein, the twist multiplier (TM) of a cord is determined according to the following equation which is well known in the textile art:

TM=0.0137 CT×(CD)^{1/2}

wherein TM is the twist multiplier; CT is the number of turns per inch (2.54 cm) of cord length; and CD is the sum of the deniers of the yarn(s), and/or sub-groups of the yarns of the cord before any twist is imparted to the yarn subgroups. The twist multiplier of a cord characterizes its physical properties, like tensile, modulus, elongation and fatigue.

According to still another aspect of the present invention, the tread reinforcement structure at least partially includes a plurality of individually dipped and individually tackified cords oriented from −7° to +7° relative to a circumferential direction of the pneumatic tire.

According to yet another aspect of the present invention, the cords are each constructed of one, two, three or more twisted aramid yarns.

According to still another aspect of the present invention, a tackified finish is applied to the cords during or after the dipping process.

According to yet another aspect of the present invention, the tackified cords are applied directly on to a carcass ply during a building process of an uncured pneumatic tire.

According to still another aspect of the present invention, the cords are constructed of one of the following materials: aramid, PEN, PET, PVA, PBO, POK, rayon, nylon, carbon, and glass fiber.

A method in accordance with the present invention constructs an integral belt/overlay component of a pneumatic tire. The method preferably comprises the steps of: first, pretreating an individual cord by dipping the cord in a first solution or emulsion; second, drying the individual cord; third, tackifying a surface of the dipped and dried individual cord with a second solution or emulsion; and fourth, applying the tackified individual cord on a surface of an uncured tire component.

According to another aspect of the present invention, the tackified individual cord is applied to the uncured tire component on a tire building drum.

According to still another aspect of the present invention, the second solution or emulsion comprises a rubber compound dissolved in a solvent. Preferably, the solvent comprises a petroleum derivative such as toluene.

According to yet another aspect of the present invention, the applying step occurs without calendering of the individual cord.

According to still another aspect of the present invention, the dipping includes dipping the individual cord in the first solution or emulsion, and applying an adhesion promoter and/or dipping the dipped individual cord in a further solution or emulsion prior to the drying step.

According to yet another aspect of the present invention, the further solution or emulsion is an aqueous emulsion comprising a rubber latex containing resorcinol formaldehyde (RFL) resin.

### BRIEF DESCRIPTION OF THE DRAWINGS

Further aspects of the present invention will become apparent from the description of the following embodiments in conjunction with the attached diagrammatic drawing, in which:

FIG. 1 represents a schematic cross-sectional view of an example tire in accordance with the present invention;

FIG. 2 represents a schematic detail view of the bead region of the example tire shown in FIG. 1; and

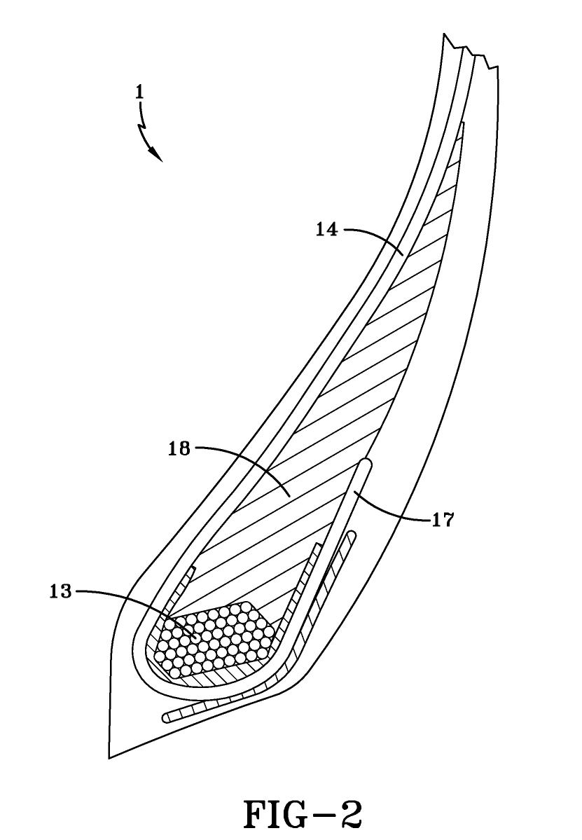

FIG. 3 represents a schematic detail view of a single ply in accordance with the present invention.

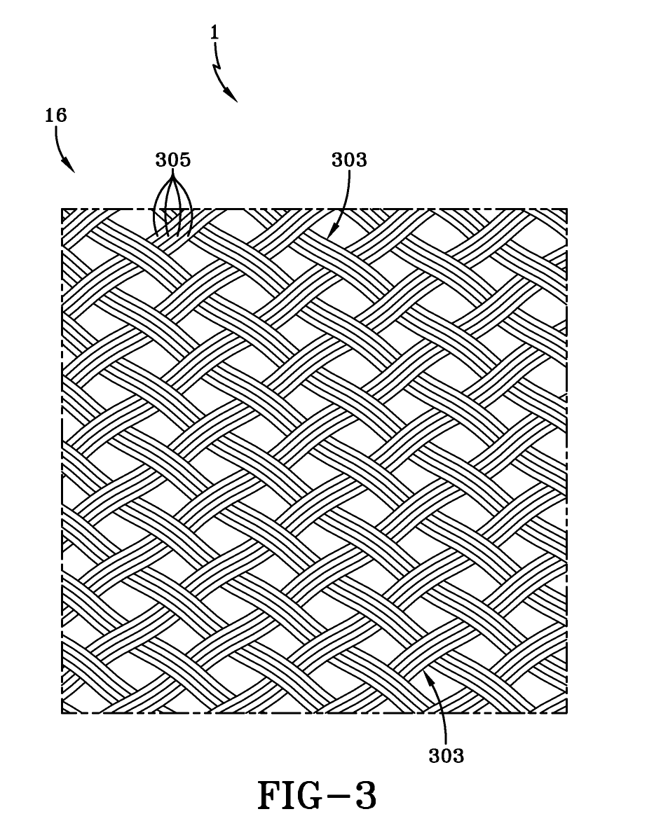

### DESCRIPTION OF AN EXAMPLE EMBODIMENT

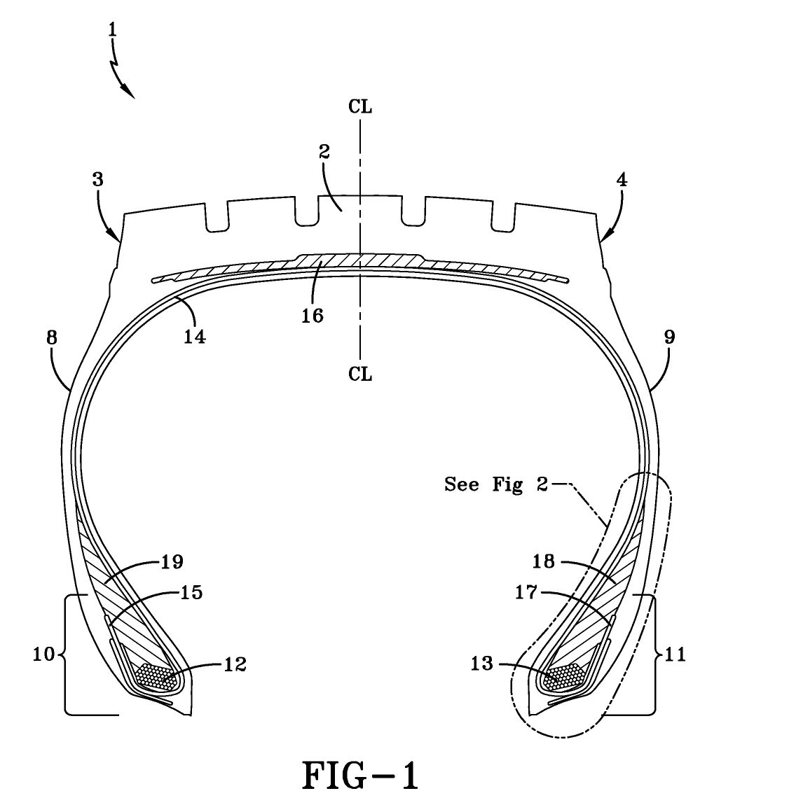

The example tire 1 of FIG. 1 includes a pair of sidewalls 8, 9 terminating in bead regions 10, 11. Each bead region 10, 11 is reinforced by an inextensible annular bead core 12, 13. Extending between each bead region 12, 13 is a tire carcass reinforcement ply structure 14 of one or more plies which is/are anchored in each bead region 10,11 by being turned around each respective bead core 12, 13 laterally from inside to outside to form each ply turn-up 15, 17. The carcass reinforcement ply structure 14 may, for example, comprise a single ply of nylon fabric cords oriented substantially in a radial direction. Each bead region 10, 11 may further comprise a hard rubber apex member 17, 18 anchored to each respective bead core 12, 13 and narrowing/tapering radially outward. The carcass ply fabric of the example tire 1 may also comprise polyester, rayon, nylon, or para-aramid cords. Further, while a single ply carcass of cords at substantially 90 degrees may be particularly advantageous in the case of tires with two plies of cords crossed at an angle of 70-88 degrees.

The example tire 1 may have a convex tread region 2, having tread edges 3, 4 reinforced by an integral breaker assembly (or belt structure)/overlay 16 in accordance with the present invention. The assembly may be a filament wound, or single end dipped, reinforcement that integrates the functionality of the belt and overlay to construct a single band of reinforcement in accordance with the present invention.

Conventional pneumatic tire designs have been based on classical composite laminate principles having several reinforcement layers in which cords are laid parallel to each other. Due to the unidirectional load carrying capability of each reinforcement layer, several such layers are stacked up to manage the force transfer in several directions. A minimum of two such reinforcement layers of steel wires has been used as a belt package along with an additional layer of reinforcement as an overlay for enhancing high speed performance. Inherent disadvantages of this conventional design are excess weight with few possible weight reductions.

The assembly 16 may eliminate the inherent disadvantages of conventional reinforcement constructions by integrating belt and overlay functionality using rubberized filament winding technology to construct a single assembly 16. Such an integral assembly 16 may further reduce weight narrowing the overlay portion of the assembly without sacrificing performance characteristics (FIG. 1). The cords 305 of the wider belt portion of the assembly 16 may have an angle relative to the circumferential direction of the tire 1 between −30° and +30°. The cords 305 of the thinner overlay portion of the assembly 16 may have an angle relative to the circumferential direction of the tire 1 between −7° and +7°.

The assembly 16 may comprise single end dipped cords 305, which are individually dipped and subsequently individually tackified (i.e., not calendered). While the cords 305 may be individually dipped, a group 303 of several cords may also be dipped concurrently, moving through a dip process/machine in parallel. For example, the individual cords may be monofilaments, para-aramid 1680/3 Dtex with 240/240 tpm (turns per meter) or other suitable configurations. The selection of materials for the tackified finish may depend greatly upon the materials selected for use in the tire 1. One of ordinary skill may determine such suitable materials. Tackified finishes may be achieved by various methods such as coating the single end cords in an aqueous or solvent blend of resin and rubber lattices.

An example method in accordance with the present invention may comprise the steps of: first, pretreating an individual cord by dipping the cord in a first solution or emulsion; second, drying the individual cord; third, tackifying a surface of the dipped and dried individual cord with a second solution or emulsion; and fourth, applying the tackified individual cord on a surface of an uncured tire component.

The second solution or emulsion may comprise a conventional un-vulcanized rubber compound dissolved in a solvent. Preferably, the solvent comprises a petroleum derivative or distillate such as toluene.

The dipping may include a treatment of the individual cord with an adhesion promoter as part of the dipping process. Typical examples of adhesion promoters include resorcinol formaldehyde latex (RFL), isocyanate based material, epoxy based material, and materials based on melamine formaldehyde resin. To this end, the dipping may include dipping the individual cord in the first solution or emulsion (or in a first bath) and subsequently dipping the dipped individual cord in a further solution or emulsion (or a second bath) prior to the drying step.

Preferably, the further solution or emulsion is an aqueous emulsion (dispersion) comprising a rubber latex containing resorcinol formaldehyde (RFL) resin. The RFL resin may be a primary element of adhesion between the cord and the rubber with the latex also reducing the modulus of the RFL resin.

The tackifying of the surface of the dipped and dried individual cord includes applying a tackified finish for facilitating adhesion, or green tack, during the building process of the green tire. The selection of materials for such tackified finish will depend greatly upon the materials selected for use in the tire, and the skilled person on the basis of his common knowledge can easily determine them appropriately. Tackified finishes can be achieved by various methods such as coating the cord in an aqueous blend of rosin and rubber lattices, or with a solvent solution or emulsion of an un-vulcanized rubber compound.

During building of the uncured tire, the cords 305 of the assembly 16 may be individually placed directly upon an outermost of one or two carcass plies 14, without any intermediate manufacturing process. The assembly 16 in accordance with the present invention may thus provide a tread crown reinforcement structure and may optimize high speed performance, as well as provide excellent handling characteristics, while reducing overall manufacturing efficiency, cost, and weight. The present invention accomplishes this by utilizing the individually dipped and individually tackified Single End Dipped (SED) cord(s) 305 to integrate the belt and overlay structures. Suitable materials for the SED cords 305 may be aramid, PEN, PET, PVA, PBO, POK, Rayon, Nylon 6, 4,6 and 6,6 , carbon, and/or glass fiber. Additionally, the cords 305 may be calendered in small strips 303 of 1, 2, 3, 4, etc. cords.

In accordance with the present invention, the cords 305 may be first dipped in a first “classical” solution and, in a second phase, tackified by a second solution or emulsion (as described above). Once the cord 305 is tackified, the cord will have enough cohesive properties to adhere to an unvulcanized component, such as the carcass 14. This provides an improvement over conventional tire building methods, which include an additional calendering step and often generate a higher amount of scrap. Further, cord properties may not be affected by calendering and storage. Also, the process provides a simpler and more efficient method, since no weft yarns are needed for weaving and calendering.

In accordance with the present invention, this “ready to use” SED cord assembly 16 may provide a “jointless” belt/overlay having a better controlled tension applied to the cords 305 during winding at a tire building machine. This may be critical for strips with multiple cords due to the curvature of a radial carcass 14. The cords 305 at the tread edges 3, 4 may have significantly shorter length compared to the cords at the center of the tread 2.

As stated above, an assembly 16 of SED cords in accordance with the present invention produces excellent handling performance in a tire 1, as well as reducing manufacturing cost and weight. Further, a method in accordance with the present invention provides enhanced efficiency and reduced cost for constructing a pneumatic tire. Thus, the SED cords 305 and method both enhance the performance and/or manufacturing of a pneumatic tire, even though the complexities of the structure and behavior of the pneumatic tire are such that no complete and satisfactory theory has been propounded. Temple, Mechanics of Pneumatic Tires (2005). While the fundamentals of classical composite theory are easily seen in pneumatic tire mechanics, the additional complexity introduced by the many structural components of pneumatic tires readily complicates the problem of predicting tire performance. Mayni, Composite Effects on Tire Mechanics (2005). Additionally, because of the non-linear time, frequency, and temperature behaviors of polymers and rubber, analytical design of pneumatic tires is one of the most challenging and underappreciated engineering challenges in today's industry.

A pneumatic tire has certain essential structural elements. United States Department of Transportation, Mechanics of Pneumatic Tires, pages 207-208 (1981). An important structural element is the overlay, typically made up of many flexible, high modulus cords of natural textile, synthetic polymer, glass fiber, or fine hard drawn steel or other metal embedded in, and bonded to, a matrix of low modulus polymeric material, usually natural or synthetic rubber. Id. at 207 through 208.

The flexible, high modulus cords are usually disposed as a single layer. Id. at 208. Tire manufacturers throughout the industry cannot agree or predict the effect of different twists of overlay cords on noise characteristics, handling, durability, comfort, etc. in pneumatic tires, Mechanics of Pneumatic Tires, pages 80 through 85.

These complexities are demonstrated by the below table of the interrelationships between tire performance and tire components.

| | | CARCASS | | | | | |
|---|---|---|---|---|---|---|---|
| | LINER | PLY | APEX | BELT | OV'LY | TREAD | MOLD |
| TREADWEAR | | | | X | | X | X |
| NOISE | | X | X | X | X | X | X |
| HANDLING | | X | X | X | X | X | X |
| TRACTION | | | | | | X | X |
| DURABILITY | X | X | X | X | X | X | X |
| ROLL RESIST | X | | X | X | | X | X |
| RIDE | X | X | X | | | X | |
| COMFORT | | | | | | | |
| HIGH SPEED | | X | X | X | X | X | X |
| AIR | X | | | | | | |
| RETENTION | | | | | | | |
| MASS | X | X | X | X | X | X | X |

As seen in the table, belt/overlay cord characteristics affect the other components of a pneumatic tire (i.e., belt/overlay affects apex, carcass ply, tread, etc.), leading to a number of components interrelating and interacting in such a way as to affect a group of functional properties (noise, handling, durability, comfort, high speed, and mass), resulting in a completely unpredictable and complex composite. Thus, changing even one component can lead to directly improving or degrading as many as the above ten functional characteristics, as well as altering the interaction between that one component and as many as six other structural components. Each of those six interactions may thereby indirectly improve or degrade those ten functional characteristics. Whether each of these functional characteristics is improved, degraded, or unaffected, and by what amount, certainly would have been unpredictable without the experimentation and testing conducted by the inventors.

Thus, for example, when the structure (i.e., twist, cord construction, etc.) of the overlay of a pneumatic tire is modified with the intent to improve one functional property of the pneumatic tire, any number of other functional properties may be unacceptably degraded. Furthermore, the interaction between the overlay and the apex, carcass ply, belt (or breaker), and tread may also unacceptably affect the functional properties of the pneumatic tire. A modification of the overlay may not even improve that one functional property because of these complex interrelationships.

Thus, as stated above, the complexity of the interrelationships of the multiple components makes the actual result of modification of an integral assembly 16, in accordance with the present invention, impossible to predict or foresee from the infinite possible results. Only through extensive experimentation have the assembly 16 and cords 305 of the present invention been revealed as an excellent, unexpected, and unpredictable option for a pneumatic tire.

The previous descriptive language is of the best presently contemplated mode or modes of carrying out the present invention. This description is made for the purpose of illustrating an example of general principles of the present invention and should not be interpreted as limiting the present invention. The scope of the invention is best determined by reference to the appended claims. The reference numerals as depicted in the schematic drawings are the same as those referred to in the specification. For purposes of this application, the various examples illustrated in the figures each use a same reference numeral for similar components. The examples structures may employ similar components with variations in location or quantity thereby giving rise to alternative constructions in accordance with the present invention.

What is claimed is:

1. A pneumatic tire comprising an integrated belt/overlay component having a plurality of individually dipped and individually tackified cords applied individually to the tire.

2. The pneumatic tire as set forth in claim 1 wherein the component is a tread reinforcement structure at least partially including a plurality of individually dipped and tackified cords oriented from −7° to +7° relative to a circumferential direction of the pneumatic tire.

3. The pneumatic tire as set forth in claim 1 wherein the cords are constructed of two or three twisted aramid yarns.

4. The pneumatic tire as set forth in claim 1 wherein a finish is applied to dipped cords during or after a dipping process, the finish providing tack to the component.

5. The pneumatic tire as set forth in claim 1 wherein the component is disposed radially between a tread and a carcass ply.

6. The pneumatic tire as set forth in claim 1 wherein the cords are applied directly on to another tire component during a building process of an uncured pneumatic tire.

7. The pneumatic tire as set forth in claim 6 wherein the tire component is a carcass ply.

8. The pneumatic tire as set forth in claim 1 wherein the cords are constructed of one of the following materials: aramid, PEN, PET, PVA, PBO, POK, rayon, nylon, carbon, and glass fiber.

9. A method for constructing an integrated belt/overlay component of a pneumatic tire, said method comprising the steps of:
pretreating an individual cord by dipping the individual cord in a first solution or emulsion;
drying the dipped individual cord;
tackifying a surface of the dipped and dried individual cord with a second solution or emulsion; and
applying the tackified individual cord on a surface of an uncured tire component.

10. The method as set forth in claim 9 wherein the tackified individual cord is applied to the uncured tire component on a tire building drum.

11. The method as set forth in claim 9 wherein the second solution or emulsion comprises a rubber compound dissolved in a solvent.

12. The method of claim 11 wherein the solvent comprises a petroleum derivative.

13. The method as set forth in claim 9 wherein said applying step occurs without calendering of the individual cord.

14. The method as set forth in claim 9 wherein the dipping includes dipping the individual cord in the first solution or emulsion and dipping the dipped individual cord in a further solution or emulsion.

15. The method of claim 14 wherein the further solution or emulsion is an aqueous emulsion comprising a rubber latex containing resorcinol formaldehyde (RFL) resin.
